(19) United States
(12) Patent Application Publication
(10) Pub. No.: US 2012/0116865 A1
(43) Pub. Date: May 10, 2012

(54) Cooperative Purchasing System That Utilizes SNS, and Method Thereof

(75) Inventors: Hikaru Deguchi, Tokyo (JP); Fujio Yamazaki, Tokyo (JP); Yoshikazu Takasaki, Tokyo (JP)

(73) Assignees: MEKIKI CREATES CO., LTD., Shibuya-ku, Tokyo (JP); MEKIKI CO., LTD., Shibuya-ku, Tokyo (JP)

(21) Appl. No.: 13/262,824

(22) PCT Filed: Apr. 2, 2010
(86) PCT No.: PCT/JP2010/056099

§ 371 Date: Nov. 30, 2011

(30) Foreign Application Priority Data
Apr. 3, 2009 (JP) 2009-090663

(51) Int. Cl. G06Q 30/02

(52) U.S. Cl. 705/14.39; 705/26.41

(57) ABSTRACT

What is presented is consolidating purchasing power and points into an SNS with payment of an individual member's shopping covered in advance by the SNS, and providing system and method to return benefits obtained thereby to SNS Members. SNS1's system control computer [5] has communicable connection with an affiliate store [4]'s terminal [6] and a financial institution [2] where SNS Account [3] has been opened under the SNS's name, and the computer [5] includes member information DB that memorizes a member [7]'s payable amount and store information DB that memorizes the affiliate store's settlement institution. It also includes and consists of the following systems: when the member [7] who shops at the store [4] wishes payment through SNS Account [3], it judges whether the price is within payable amount and extracts the store [4]'s settlement institution from the store information DB and directs the financial institution [2] where SNS Account [3] has been opened to remit to such settlement institution, and renews payable amount of the member [7] who shopped.

### TECHNICAL FIELD

The present invention relates to a system and a method for allowing an SNS (Social Networking System) to make payment for an SNS member's personal shopping on behalf of the member, thus concentrating purchasing and points on the SNS and returning profits obtained thereby to the SNS member.

### BACKGROUND ART

With spread of the Internet, various new types of services and systems have appeared, and the SNS is one of them. The SNS is originally a system for the purpose of building up a circle of friends, but there is a trend of utilizing the SNS not only as means for building a personal connection but also for business. For example, Patent Document 1 discloses a membership-based Web electronic money site management system for providing settlement service using SNS and membership-based electronic money through website of a cell phone.

### PRIOR ART DOCUMENT

### Patent Document

Patent Document 1 Japanese Patent Application Laid-Open No. 2003-305112

### SUMMARY OF INVENTION

### Problem to be Solved by the Invention

Although a system described in the Patent Document 1 is configured such that a member settles the price through an account of a management company of the system, advantages obtained by an account of the management company making payment on behalf of the member are noticed. If assuming that the management company having a payment settlement account is one fictional giant consumer, several advantages utilizing a scale merit (preferential treatment such as discount or adding points) may be obtained, but any system for returning these advantages to members cannot be found.

The present invention aims at proposing a mechanism for returning advantages obtained by an SNS operational main body (hereinafter referred to as “SNS”) making payment on behalf of individual members to the members, thus allowing the SNS, members and affiliated shops to enjoy actual benefits all together.

By the way, point services for sales promotion have been already performed by various retailers. They are, however, prohibited from being leased and assigned to others, and a card will become invalid unless used for a predetermined period of time. The present invention also aims at proposing a mechanism for enabling to exchange points and reducing a risk of invalidating a card due to its expiration.

### Means for Solving the Problem

In order to achieve the purpose, the present invention relates to a group purchase system using the SNS where payment of product purchase price by an SNS Member is made by withdrawal from an account opened at a financial institution under the name of such SNS (hereinafter “SNS Account”), wherein.

the group purchase system control computer and store computer used by an affiliate store that provides products are connectable to each other via the Internet, and the control computer comprises a memory section and a processing section, wherein

the memory section includes:
a member information database that memorizes by corresponding a member's identification information to payable amount;
a store information database that memorizes by corresponding an affiliate store's identification information to settlement institution;
a purchase history database that memorizes history of purchase by a member at an affiliate store; and
a settlement information database that memorizes by corresponding settlement date and settled amount to settlement institution,

The processing section includes:

an inquiry response system that receives from the store computer sales suitability inquiry request, and member identification information and price of product which such member wishes to purchase, and that responds whether the product price is within the limit of such member's payable amount extracted from the member information database;

a purchase history registration system that registers purchase information including the price transmitted from the store computer and store identification information into the purchase history database when the product price is within the payable amount;

a Settlement direction system that extracts a settlement institution of the store that transmits the purchase information from the settlement information database, and directs the financial institution where the SNS Account has been opened to remit money into the store's settlement institution from such SNS Account at the prescribed timing; and

a payable amount management system that set and renews payable amount of each member in the member information database.

“Stores” include not only solid stores, but also online shopping sites.

A “store computer” is equivalent to a store terminal in case of the following practice manner.

“Products” include not only tangible products, but also intangible products (services).

There are two types of SNS; a type that requires invitation from an existing member in order to acquire membership, and another type that accepts anyone, but the present invention is applicable to both. However, the first type is more favorable in the view of external credit acquirement.

Not only consumers, but also stores can be members of the present system. It is because stores conduct not only production and sale, but also purchase.

If a store enters the present system, it can receive benefit not only as a consumer, but also benefit to advertise by using SNS. The Internet advertisement function based on SNS is brilliant.

As mentioned, with SNS as a payment contact, all individual shopping behaviors by SNS members are deemed as SNS's shopping solely, and therefore, discounts and acquired points are naturally consolidated to SNS because a purchasing subject becomes SNS.

SNS can be deemed as a “giant consumer” because SNS purchases and makes payment as an agent. It is general that each consumer is overwhelmingly weaker than vendors, but SNS in the present system can take a strong position as a giant consumer. Advantage of scale may be also expected in discounts and point acquirement compared to general consumers. This advantage of scale is eventually returned to the members. In the current SNS, there is no specific economic return from the SNS operator to the members, but the present system can bring in pragmatic benefit to the members.

Furthermore, in the present system, SNS-specific functions can be utilized because SNS is the management body. For example, the following functions may be used: a function of communication on BBS with themes such as hobby and local area; a function to register a new acquaintance; advertisement posted in the site; a function to recommend products and services to friends, etc. Therefore, it has an advantage that members increase without special cost. As members increase, the position of SNS as a consumer is strengthened, and return to the members thereby is enriched. A good advertising function also helps increase affiliate stores. This leads to competition between stores of the same kind, and the members can purchase good quality products for reasonable prices.

In order to achieve the above described purpose, the system control computer further comprises an acquired point database and a point management system, and the point management system registers valuable information issued to the SNS by an affiliate store where a member purchased a product, and may also register such store's identification information into the acquired point database, as well as tallying, renewing and registering the valuable information acquired for each member into the member information database. “Valuable information” is equivalent to “points” in case of the following manners. Namely, “points” of point service provided by various retailers.

Points are thereby accumulated in a lump sum into the SNS, and each member can use their preferable points among the accumulated points (there are points of stores where they never purchased products.). That is to say, actual point exchange becomes possible.

In order to achieve the above described purpose, the system control computer comprises an account activity inquiry system to inquire account activity regarding the concerned SNS Account to the financial institution where the SNS Account has been opened and when the account activity system receives the member's identification information and deposit information including deposit amount, and the payable amount management system may add the received deposit amount to such member's payable amount in the member information database.

As deposit methods, there are general remittance and deposit by electronic money.

In order to achieve the above described purpose, the payable amount management system may add amount within the credited limit to a member's payable amount in the member information database in regard to such member credited with the prescribed limit amount by the concerned SNS or financial institution that conducts credit operations. Products can be thereby purchased although there is no cash in hand that can be deposited into SNS Account.

In order to achieve the above described purpose, the payable amount management system may add to payable amount in the member information database the amount converted from all or part of the acquired points of such member by the prescribed method. Additionally, the member information database may include information indicating a member's age and the payable amount management system may add the converted amount only for a member whose age fulfills the prescribed condition.

“Information indicating age” is equivalent to date of birth in case of the following manners.

For example, if arrangement is provided that pints may be used from age of 60, it can substitute the future pension.

A member terminal used by an SNS member is connectable to the system control computer via communication network, and the system control computer should be further equipped with member information provision system which transmits information regarding such member including the payable amount and the purchase history in response to request from the member terminal.

Members can use the present system safely because they can thereby browse their own use record at any time and rapidly figure out damage in case of a third party's fraud.

The method to operate a computer as the system control computer for the above described group purchase system is also to achieve the purpose of the present invention.

The present invention may tend to be focused on with its similarity to the existing consumer cooperative (Co-op) due to its nature of SNS's consolidation of consumption activities of each member. However, the present system and Co-op are more different than might first be surmised as described below.

Co-op conducts group purchase activities to purchase products cooperatively and sell them at retail to the members as its main business. On the other hand, in the present invention, the SNS main body, namely, the system, does not assume that it conducts purchase and retail.

Additionally, Co-op is limited to development in narrow societies such as local areas and colleges. In the case of the present invention, conversely, participation in the SNS becomes possible with connection to communication network regardless of where the residence is. That is, the present system is developable nationwide. Furthermore, large amount of information is exchanged between the members via communication network, including information regarding products and commercial bodies. If the SNS applies membership system, information reliability is improved. Exposure to large amount of reliable information evokes participants' willingness to buy. The present system has potential to create one giant virtual consuming body and affect the entire industry.

In addition, some Co-ops apply point service for store users, but points acquired by each individual are managed and used by themselves. However, in the present invention, point services of all affiliate vendors of the present system are usable, which makes it convenient (in the case of Co-op, it is limited to its own store.). It is also flexible such that each member can use various vendors' points because SNS manages points at a lump sum,

### Effect of Invention

Each SNS member's product purchase price payment is paid in advance by the SNS, and purchasing power and points are consolidated into the SNS. Benefit gained thereby can be returned to the SNS members.

### BRIEF DESCRIPTION OF DRAWINGS

FIG. 1 The entire configuration diagram that shows overview of the system that realizes the group purchase system regarding the first embodiment.

FIG. 2 A simplified block diagram that shows the system control computer function regarding the first embodiment.

FIG. 3 A data structure diagram that shows a sample of member information regarding the first embodiment.

FIG. 4 A data structure diagram that shows a sample of store information regarding the first embodiment.

FIG. 5 A data structure diagram that shows a sample of purchase history information regarding the first embodiment.

FIG. 6 A data structure diagram that shows a sample of settlement information regarding the first embodiment.

FIG. 7 A diagram that explains the entire processing summary of group purchase system regarding the first embodiment.

FIG. 8 A flow chart that shows a processing flow in the system control computer for the first embodiment.

FIG. 9 A flow chart that shows a processing flow in the system control computer for the first embodiment.

FIG. 10 A flow chart that shows a processing flow in the system control computer for the first embodiment.

FIG. 11 A simplified block diagram that shows the system control computer function regarding the second embodiment.

FIG. 12 A data structure diagram that shows a sample of store information regarding the second embodiment.

FIG. 13 A flow chart that shows a processing flow in the system control computer for the second embodiment.

FIG. 14 A data structure diagram that shows a sample of purchase history information regarding the second embodiment.

FIG. 15 A data structure diagram that shows a sample of member information regarding the second embodiment.

FIG. 16 A data structure diagram that shows a sample of acquired point information regarding the second embodiment.

FIG. 17 A flow chart that shows a processing flow in the system control computer for the second embodiment.

### FORMS TO PRACTICE THE INVENTION

### The First Embodiment

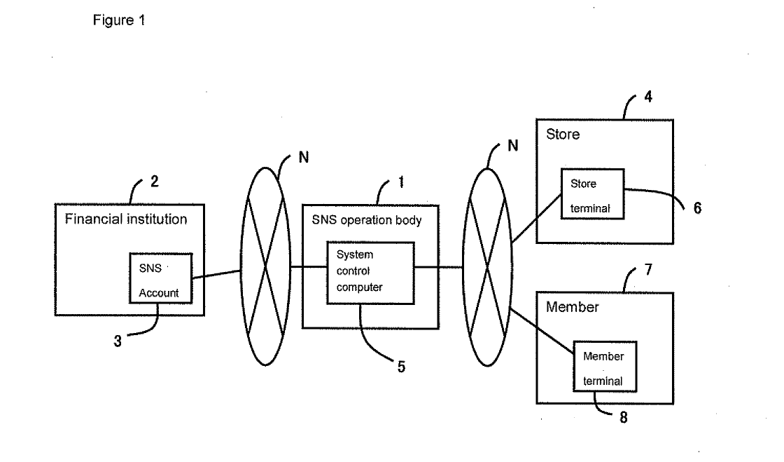

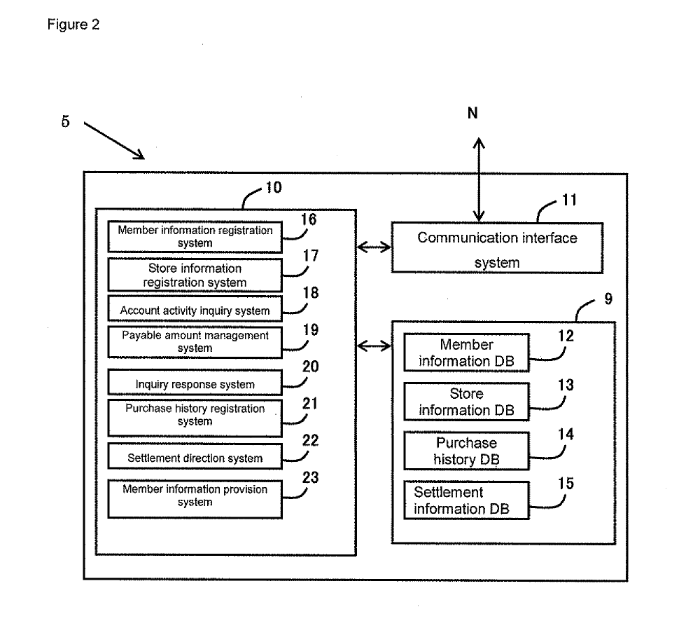

The following is an explanation of an embodiment of the present invention referring to the drawings. FIG. 1 is the entire configuration diagram that shows overview of the system of this embodiment (hereinafter “the Present System”), and FIG. 2 is a simplified function block diagram that shows configuration of the system control computer applied in the Present System.

In the present embodiment, a case is explained when an SNS member [7] (hereinafter “SNS Member”) deposits fund into SNS Account [3] opened at a financial institution [2] under the name of SNS by the SNS operator [1], purchases a product from a store [4] designated as an affiliate store by the SNS operator [1], and pays the price through SNS Account [3] within the limit of deposited fund.

As shown in FIG. 1, the group purchase system used in the present embodiment is installed by the SNS operator [1] and has the system control computer [5] stored with various data and program required in this system, the terminal of financial institution [2] where SNS Account [3] has been opened, the store terminal [6] used by the store to which purchase payment is made through SNS Account [3] and the member terminal [8] used by SNS Member [7] whose fund is deposited to and also whose purchase price is withdrawn from SNS Account [3]. Then, the system control computer [5] is configured to be able to conduct transmission and receipt of information with the store terminal [6] and SNS member terminal [8] via communication networks [N] such as the Internet, wired telephone line, wireless telephone line, CATV (cable television) line, etc.

Here, the store terminal [6] means a personal computer and mobile phone owned by a store with connection to conduct transmission and receipt of information with the system control computer [5]. In the present embodiment, including activities conducted by a store via such terminals, the store's activities may be explained by simply calling them as an “affiliate store.”

The member terminal [8] means a personal computer and mobile phone owned by a member with connection to conduct transmission and receipt of information with the system control computer [5]. In the present embodiment, including activities conducted by a member via such terminals, the member's activities may be explained by simply calling them as a “SNS Member.”

Information transmission between members and stores, and the system control computer [5] is solely done via web pages. Therefore, the member terminal [8] and store terminal [6] are required to have screen display function and software called a web browser. System using the Internet such as SNS reads files written in HTML and displays on screen; this is generally used as the user interface. Explanation on the user interface, therefore, is omitted.

This system control computer [5] consists of memory section [9], processing section [10] and communication interface system [11] as shown in FIG. 2.

The memory section [9] consists at least of member information database [12], store information database [13], purchase history database [14] and settlement information database [15]. This memory section [9] is implemented in hard disk drive or database server which is separate from the system control computer [5].

The processing section [10] consists at least of member information registration system [16], store information registration system [17], account activity inquiry system [18], payable amount management system [19], inquiry response system [20], purchase history registration system [21], settlement direction system [22] and member information provision system [23]. These systems of the processing section [10] are achieved mainly by CPU (not indicated in the figure) reading prescribed programs from memory media such as CD-ROM onto the memory and executing them.

The system control computer [5], although not indicated in the figure, memorizes operating system, various application programs, various data and HTML files on which web pages are written, into hard disk drive, RAM, etc. Additionally, inputting tools such as a keyboard and mouse and outputting tools such as a display and printer are equipped when necessary.

Functions of the system control computer [5] can be shared by multiple computers. For example, information transmission with members and stores is solely done via web pages, but a web server to manage this website may be separately installed.

Member information registration system [16] accepts personal information regarding an SNS Member who participates in the SNS and who wishes to do shopping at an affiliate store by using the Present System, and memorizes such information into member information database [12].

Here, information regarding an SNS Member means member ID provided to the member by the Present System, information that identifies the member such as address and name and information referable by the Present System for purchase permission judgment such as the member's payable amount that indicates the amount such member can purchase within the prescribed period. Member ID is issued by member information registration system [16] in accordance with the preliminarily stipulated rule.

Store information registration system [17] cooperates with the Present System and accepts information regarding an affiliate store who wishes to receive purchase price payment through SNS Account [3] and memorizes such information as well as store ID provided by the Present System to the store into store information database [13].

Store ID is issued by store information registration system [17] in accordance with the preliminarily stipulated rule.

Account activity inquiry system [18] conducts processing to inquire transactions such as deposit, withdrawal, transfer and remittance in SNS Account [3] managed by the financial institution [2]. Deposit into SNS Account [3] includes remittance from members and fund transfer between accounts in a form using electric money.

Payable amount management system [19] conducts processing to set payable amount and renewal for members in the above mentioned member information database [12]. When information of deposit from the member into SNS Account [3] is acquired by account activity inquiry system [18], the acquired deposit amount is added to the concerned member's payable amount.

Inquiry response system [20], when any member wishes to do shopping at an affiliate store, accepts inquiry from the affiliate store about availability of settlement through SNS Account [3], judges whether advance payment from SNS Account [3] is possible and notifies the affiliate store thereof.

Store terminal [6] transmits member ID of the member who wishes to do shopping and the product price. Therefore, payable amount is extracted from database with this member ID as the key, and if this amount is not smaller than the product price, the system judges settlement from SNS Account [3] is possible and transmits notification to the store terminal [6] that advance settlement is possible.

Purchase history registration system [21], when purchase information of a member who is notified by inquiry response system [20] as being capable for settlement is transmitted from the store terminal [6], receives and conducts processing to register such information into database.

That is, store ID as well as member 1D of the concerned member and purchase information including the purchased product and purchase price. Therefore, such information is registered into purchase history database [14] and the amount calculated by deducting the purchase price from the payable amount of such member in member information database [12] is written as renewed payable amount. At the same time, by referring to store information database [13] based on the store ID, account number, settlement amount and settlement date of the concerned store are registered in settlement information database [15]. The settlement date is determined in advance when registering the concerned store as an affiliate store, such as immediately, or on the 27th day of the following month with closing on the final day of a month.

Settlement direction system [22] refers to settlement information database [15] and directs the financial institution [2] where SNS Account [3] has been opened to remit payment into the settlement institution of the concerned store from SNS Account [3] if payment due has arrived.

The system control computer [5] only needs to transmit signal to request the financial institution [2] where SNS Account [3] has been opened of fund transfer into the account opened by the store. Fund transfer between accounts may be done by using the existing system such as Internet banking.

Member information provision system [23] transmits information on the concerned member including the above mentioned payable amount and the above mentioned purchase history for inquiry from the member terminal [6].

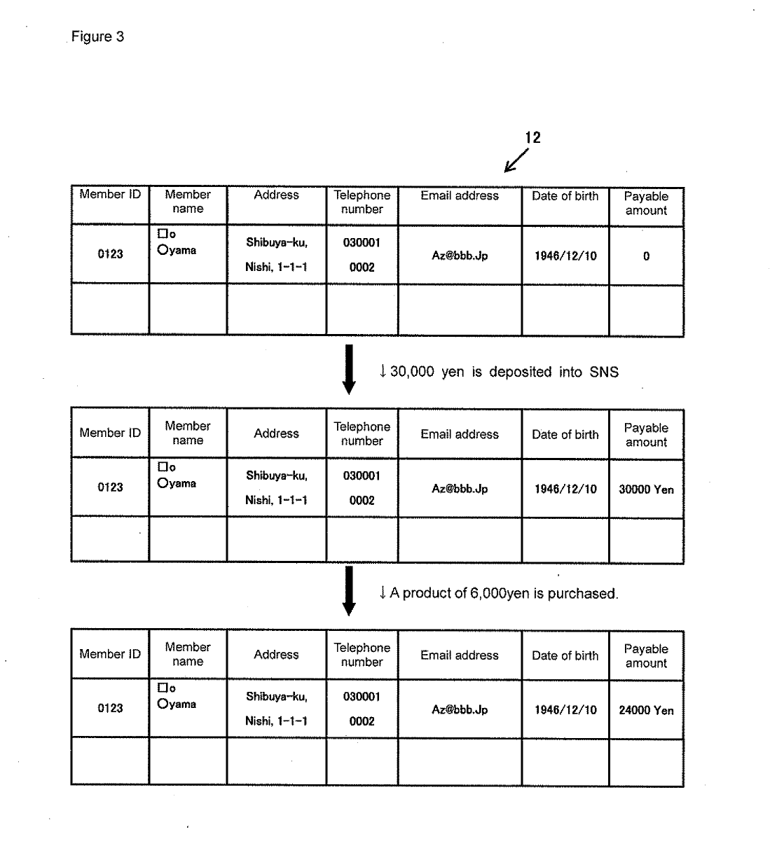

In member information database [12], for example, as shown in FIG. 3, personal information such as name, address, telephone number, email address, date of birth of a member as well as the member's payable amount for shopping through SNS Account [3]. Besides, authorization information such as information regarding the member's personal account, PIN number and fingerprint data to authorize the member are also memorized if necessary.

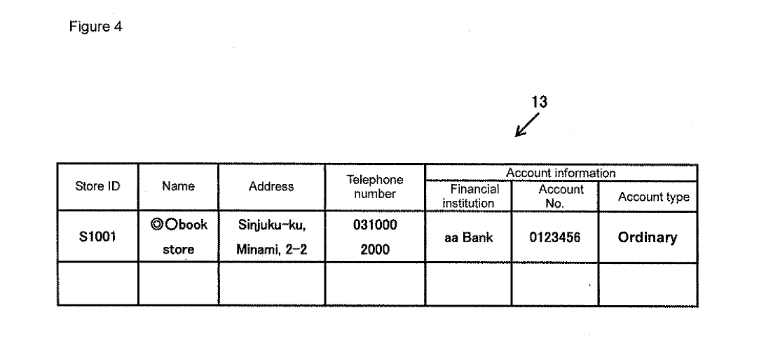

In store information database [13], for example, as shown in FIG. 4, information that can identify the store such as address, name, telephone number, etc. and information that can identify the account such as name of the financial institution where the store opened an account, account number, account type, etc. are memorized by corresponding them to the store ID. Besides, information to authorize that it is a legitimate store, is also memorized if necessary.

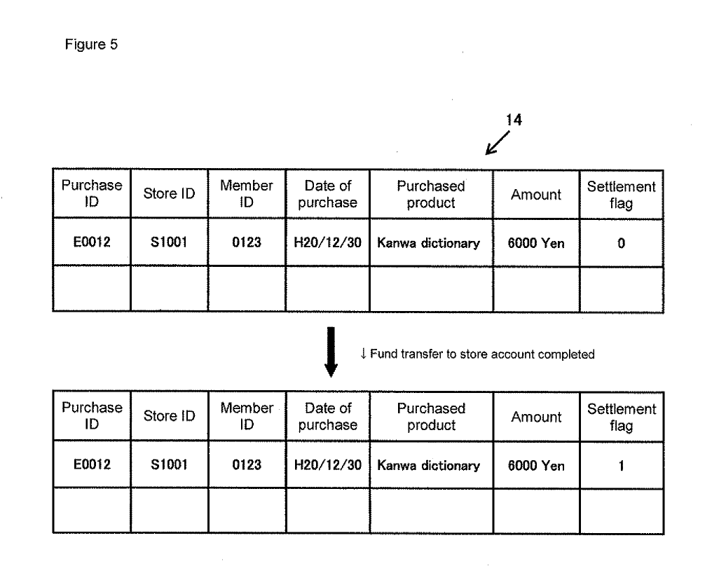

In purchase information database [14], for example, as shown in FIG. 5, purchase ID provided by the system as well as who purchased at which shop, when, what and for how much are memorized. Additionally, information of whether such purchase price has been paid out is also memorized.

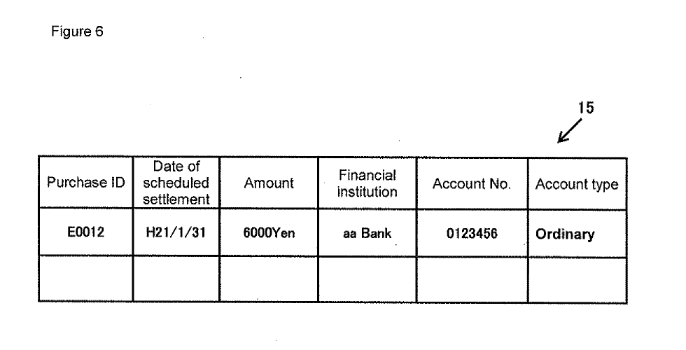

In settlement information database [15], for example, as shown in FIG. 6, ID that specifies an event of purchase, information of when and where and how much is remitted is memorized.

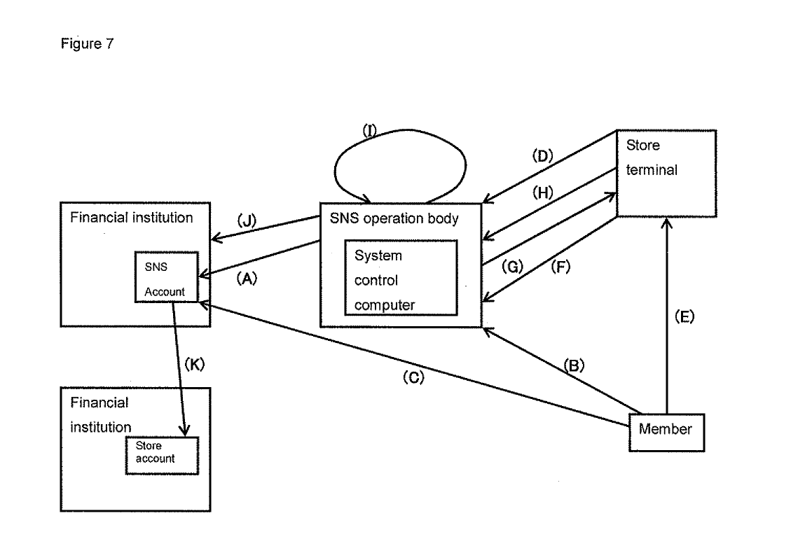

Next, summary of processing in the Present System which is composed as above is explained referring to FIG. 7.

The SNS operator opens SNS Account [3] at a financial institution [2] (Step [A]). This SNS Account [3] is the account where payment of the members' purchase price is paid in advance by the SNS and such financial institution's name, the number and type of the account opened are announced.

A participant that wishes to purchase a product by using this system signs up for membership of the Present System at the SNS operator (Step [B]). Membership registration system has necessary information memorized in member information database [12]. For example, as shown in FIG. 3, a member whose name is “□o ∘yama,” whose address is “1-1-1 Nishi, Shibuya-ku,” whose telephone number is “0300010002” and whose email address is “Az@bbb.jp” is newly registered and memorized by corresponding to member ID “0123” provided by the Present System.

It can either allow any participants of the concerned SNS can be members of the Present System by the above registration, or allow only those who pass screening of the Present System can be members.

Those who sign up for membership deposit the prescribed or arbitrary amount into SNS Account [3] (Step [C]). Deposit can be done by any method such as remittance and electric money, etc. Account activity inquiry system [18] figures who deposits how much into SNS Account [3], and payable amount section in member database [12] is renewed. In a sample shown in the middle row of FIG. 3, a member “□o ∘yama” currently has deposited money of 30,000 yen in SNS Account. The member deposits money into SNS Account [3] as many times as needed at appropriate timing when they wish to purchase an expensive product or when payable amount reduces.

A store that wishes to receive advance payment service from SNS Account [3] by using the Present System registers at the SNS operator as an affiliate store of the Present System (Step [D]). Store information registration system [17] has store information database [13] memorize necessary information. For example, as shown in FIG. 4, a store whose name is “\textcircled{∘}∘ Bookstore,” whose address is “2-2 Minami, Shinjuku-ku,” and whose telephone number is “0310002000” is newly registered and memorized by corresponding to store ID of “S1001” provided by the Present System.

After above Step [A], [B], [C] and [D] are processed, the registered member can do shopping at a registered store and have SNS make advance payment of the shopping on behalf of the self. Processing in Step [B] and [D] is arbitrarily done whenever there is a new member or store to be registered.

Next, the member wishes to do shopping (Step [E]). There may be multiple shopping forms.

For example, the following forms can be considered.

The first form: if a card with member ID is issued at sign-up to become an SNS Member, such member shows this card to a store after deciding what to purchase and at the same time the member inputs authorization information in the store terminal [6] that is being connected to the system control computer [5].

The second form: After deciding what to purchase, the member inputs member ID and authorization information in the store terminal [6] that is being connected to the system control computer [5].

The third form: The member accesses the Internet shopping site provided by an affiliate store, and specifies a product to purchase as well as inputting member ID and authorization information.

In the Present System, the form of shopping does not matter, but the above second and third forms have advantages because they do not require the card, which saves a step of card issuance and omits possibility of a member's losing the card.

A store transmits member ID who wishes to purchase and price of such product to be purchased to the system control computer [5] (Step [F]).

Inquiry response system [20] refers to member information database [12] based on the received member ID and extracts the concerned member's payable amount. If the transmitted product price is under payable amount, advance settlement by the SNS is possible and notification is made to the store that the product can be purchased (Step [G]).

The store that receives notification of the concerned member's purchase permission from the Present System sells the product as well as transmitting purchase history information such as the sold product, product price and sales date to the system control computer [5] (Step [H]).

The system control computer [5]'s purchase history registration system [21] registers the received information in purchase history database [14], payable amount management system [19] renews payable amount in member information database [12] and settlement direction system [22] registers the concerned store's account information, amount and settlement date in settlement information database [15] (Step [I]).

Settlement direction system [22] periodically refers to settlement information database [15], and if settlement-required data of which settlement data has arrived is found, it requests the financial institution [2] where SNS Account [3] is opened for fund transfer from SNS Account [3] to the concerned store's account (Step [J]).

The financial institution [2] that receives the request transfers fund to the store's account requested in accordance with agreement between the financial institutions (Step [K]).

In addition, fund transfer between accounts can be done easily by using the existing Internet banking system.

The above is the summary of flow from shopping by an SNS Member at an affiliate store to advance payment of such price by the SNS.

Affiliate stores can have transaction with the SNS, a virtual giant consumer, and reliably receive payment. Affiliate stores often provide added value such as discount and exclusive gift for members in order to keep such a powerful consumer as their customer, and the members can enjoy such advantage of scale. For example, provided that 10% discount is given in return of use of SNS Account [3] although the original product price is 1,000 yen. If among discounted 100 yen, 20% (20 yen) is received by the SNS as commission and the remaining of 80% (80 yen) is returned to such member's payable amount, the member has resultingly bought the product of 1,000 yen for 920 yen.

As mentioned above, the Present System brings in benefits to all of affiliate stores, members, and SNS that can receive commissions, and contributes to expansion of individual consumption.

Next is explanation of a sample of operations on the system control computer [5] in the system of the above configuration.

Processing of the system control computer [5] is broadly classified into the followings and such processing is independently executed.

First: Processing to register and renew a store and member.

Second: Processing to figure deposit from a member which corresponds to Step [C] in FIG. 7 on the system side.

Third: Processing that conforms to purchase by a member corresponding to Step [F]˜[I].

Fourth: Processing to direct settlement to a financial institution corresponding to Step [J].

Member registration processing is done in the following manner. A member who wishes to sign up accesses the Present System, has a webpage for member registration display on the member terminal [8] and inputs the prescribed information such as name and email address. Then member information registration system [16] has member information database [12] memorize such inputted information. Affiliate store registration processing is done in the same manner. A member information registration sample is as shown in FIG. 3 and store information registration sample is as shown in FIG. 4.

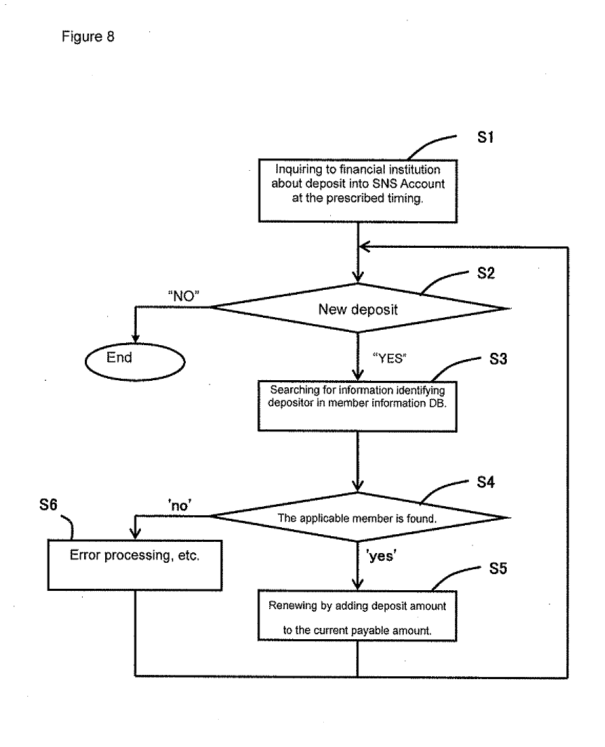

Processing for the system to figure deposit from the member that conforms to Step [C] in FIG. 7 is explained in accordance with FIG. 8.

Account activity system [18] inquires to the financial institution [2] where SNS Account [3] is opened, information regarding deposit within the prescribed period at preliminarily determined timing (i.e. once at 9:00 a.m. every day) (Step S1). If there is new deposit information (“YES” in Step S2), it searches in member information database [12] based on information that identifies the member, such as member ID (Step S3). If there is no record of such member (“NO” in Step S4), it judges that it is not deposit from the member, and does appropriate processing such as error process. If there is record of such member (“YES” in Step S4), payable amount of the concerned member is extracted and renewed by adding the deposited amount (Step S5). The processing after Step 53 is repeated until there is no new deposit data.

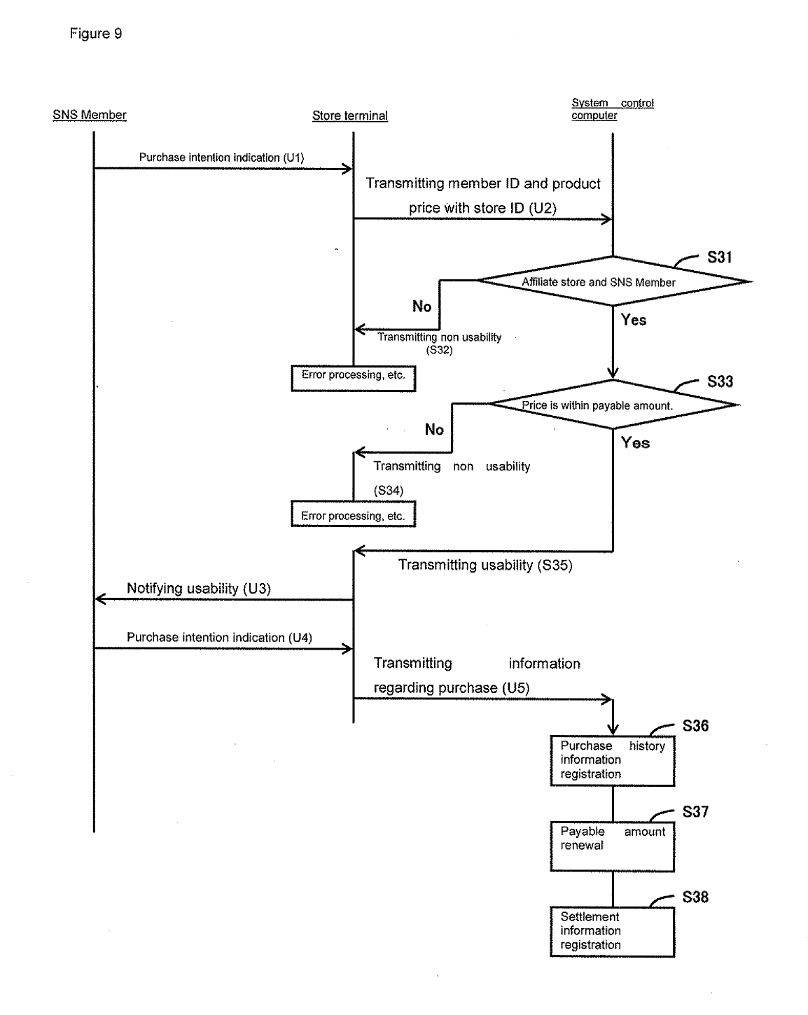

Next is an explanation of processing that conforms to purchase by a member corresponding to Step [F]˜[I] in accordance with FIG. 9. In the following explanation, indication “U*” means a user, namely, a member or store's processing, and indication “Step S*” means processing of the system control computer [5].

When receiving intention of purchase from a member (U1), a store transmits member ID who wishes to purchase and authorization information, price of the product desired with store ID to the system control computer [5] (U2).

Inquiry response system [20] searches member data which matches the received member ID and authorization information from member information database [12]. At the same time, it searches store data that matches the received store ID from store information database [13] (Step S31). Purchase using the Present System is not permitted (Step S32) if at least either of member and store does not exist in the database (“NO” in Step S31), and the store does not sell the product, or accepts purchase by other payment method such as cash payment.

When a member wishes to shop at an affiliate store (“YES” in Step S31), member information database [12] is referred to based on member ID, such member's payable amount is extracted, and the transmitted product price is judged whether it is within the payable amount (Step S33). If it is within the payable amount (“YES” in Step S33), advance settlement by the SNS is possible, and its purchase permission is transmitted to the store (Step S35). If it exceeds the payable amount (“NO” in Step S33), its status of purchase incapability is transmitted (Step S34), and the store does not sell the product, or accepts purchase by other payment method such as cash payment.

When the store receives the purchase permission by such member from the system control computer [5], it notifies the SNS Member of permission to use the Present System (U3), confirms the member's purchase intention (U4) and sells the desired product as well as transmitting purchase information such as the sold product, product price and sales date, and store ID and member ID to the system control computer [5] (U5). When the system control computer [5] receives such information, purchase history registration system [21] registers the received information in purchase history database [14] (Step 836), payable amount management system [19] renews by deducting the product price from the payable amount (Step S37) and settlement direction system [22] registers the concerned store's account information, and amount and settlement date in settlement information database [15] (Step S38).

For example, history that a member of member ID “0123” purchased a “kanwa (Chinese character)” dictionary of 6,000 yen at a store of store ID “S1001” on Dec. 30, 2008 is recorded in purchase history database [14] as shown in FIG. 5. Here, purchase ID “E0012” is issued by the Present System and distinguished from other purchase history. In this sample, in member information database [12], 24,000 yen, calculated by deducting the purchase amount of 6,000 yen from 30,000 yen before purchase is recorded as the current payable amount for renewal as shown in the lower row of FIG. 3. Settlement information is memorized as illustrated in FIG. 6. In regard to payment that corresponds to purchase ID “E0012,” it is memorized that 6,000 yen should be remitted into the account of the store with store ID “S1001” (account information extracted from store information database [13]” ordinary account: 0123456 opened at Bank “aa” on Jan. 31, 2009.

In case that immediate payment at purchase has been agreed between the Present System and a store, settlement is done immediately at purchase, but in other cases, it is registered in settlement information database [15] and processing is done when the settlement date arrives thereafter (processing of Step [J] in FIG. 7).

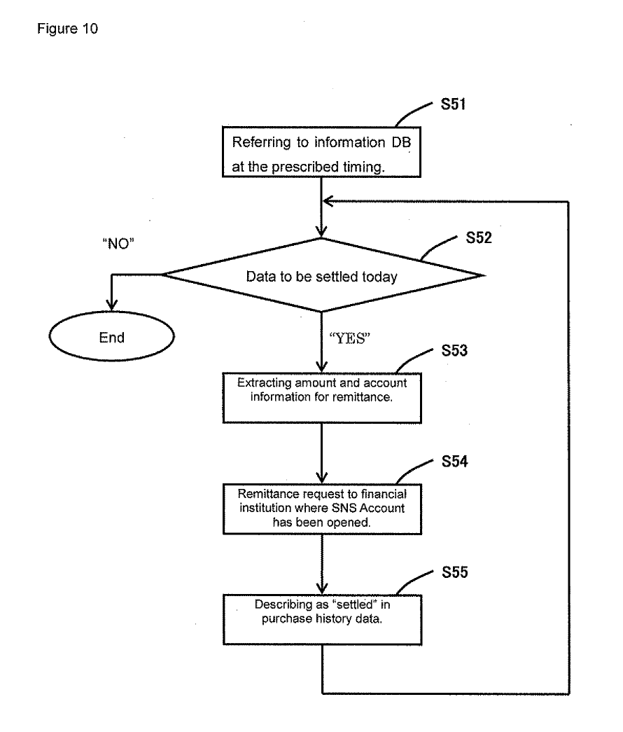

This processing is explained in accordance with FIG. 10.

Settlement direction system [22] refers to settlement database [15] at the preliminarily determined timing (for example, 9:00 am everyday) (Step S51). If there is data to be settled on that day (“YES” in Step S52), the amount and account information for remittance are extracted (Step S53) and transmitted to the financial institution [2] where SNS Account [3] has been opened and fund transfer from the concerned SNS Account [3] is requested (Step S54). For example, if today is Jan. 31, 2009, purchase ID “E0012” is the settlement date arrival as shown in FIG. 6. Therefore, request is made for remittance of 6,000 yen to ordinary account “01233456” of Bank “aa” from SNS Account [3].

Next, purchase history data that has the same ID as purchase ID of such settlement data is extracted from purchase history database [14], and settlement flag field is renewed (Step S55). For example, in a sample of FIG. 5, purchase ID “E0012” is settled, so settlement flag 0 is renewed as 1 that indicates “settlement completed” as shown in the lower row. Processing after Step 53 is repeated until there is no data to be settled.

When a member wishes to refer to his/her own current payable amount and past purchase history, the following manner is applied.

The system control computer [5] prepares web screen data (not illustrated) to respond to browsing request from the member and stores it in the memory system. The member inquires by inputting his/her member ID and authorization information via this web screen and member information provision system [23] confirms where he/she is the legitimate member. Data that matches the member ID is extracted from member information database [12] and purchase history database [14] and transmitted to member terminal [8].

### The Second Embodiment

Other embodiment of the present invention is explained by referring to drawings. This second embodiment is different from the first embodiment described above at the point that an affiliate store issues points for a customer and the customer who is a member can use such points. It is not different from the first embodiment except for the point system. Therefore, the same function factors (for example, “account activity system [18]”) are indicated with the same symbol and also presentation is omitted in the following explanation.

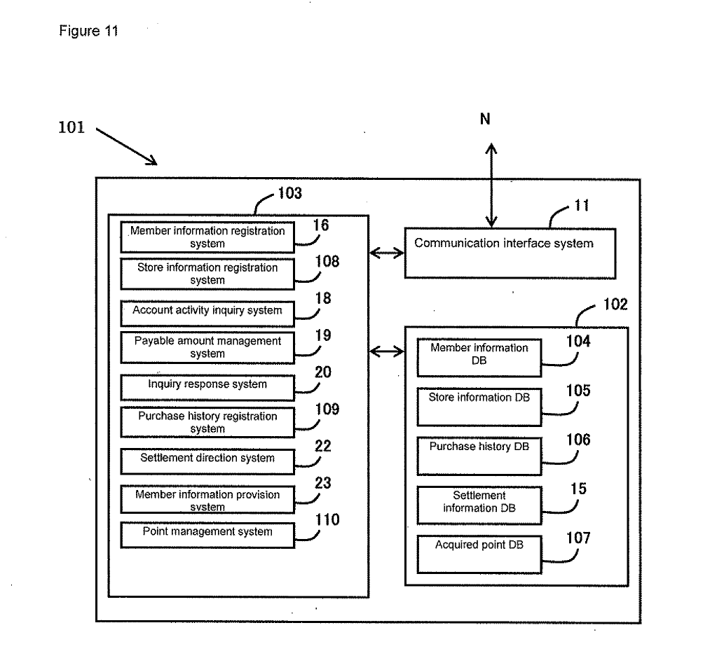

FIG. 11 is a block diagram that indicates configuration in the system control computer [101] used in the system of the present embodiment.

This system control computer [101] consists of memory section [102], processing section [103] and communication interface system [11] as shown in FIG. 11.

Memory section [102] consists at least of member information database [104], store information database [105], purchase history database [106], settlement information database [15] and acquired point database [107].

Processing section [103] consists at least of member information registration system [16], store information registration system [108], account activity inquiry system [18], payable amount management system [19], inquiry response system [20], purchase history registration system [109] settlement direction system [22], member information provision system [23] and point management system [110].

In the present embodiment, thanks to point system, store information registration system [108] confirms whether such store issues points when registering an affiliate store, and memorizes point conversion rate and expiration date in store information database [105] if points are issued.

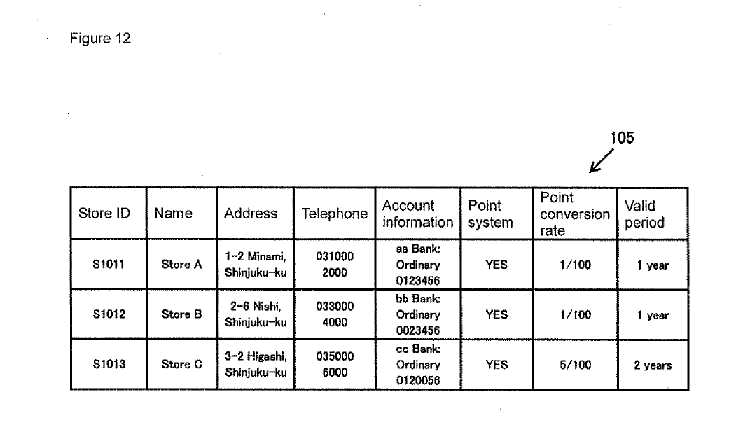

In a sample of FIG. 12, for example, Store A and Store B apply point system of conversion rate 1/100, and Store C applies point system of conversion rate 5/100. Here, conversion rate 1/100 means that purchase of 100 yen is accompanied by 1 point cashable to 1 yen. Similarly, conversion rate 5/100 means that purchase of 100 yen is accompanied by 5 points cashable to 5 yen. Store A and B's 1 point corresponds to purchase of 100 yen, but Store C's 1 point corresponds to purchase of 20 yen.

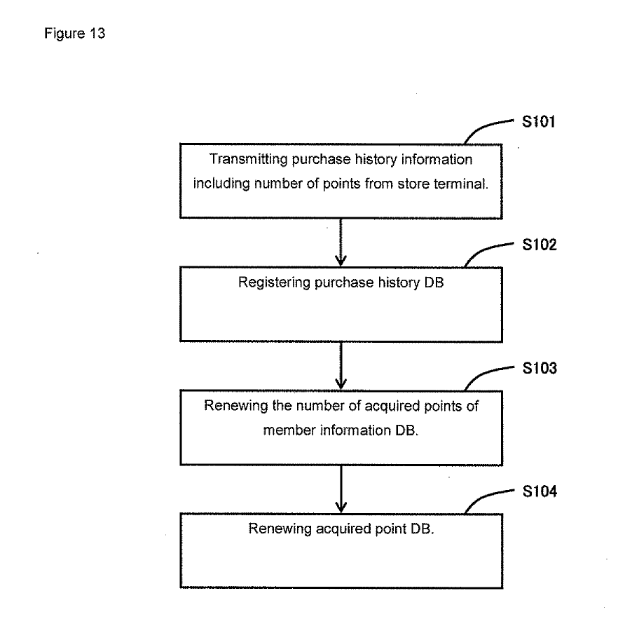

Next explanation in accordance with FIG. 13 is on processing by the system control computer [101] when a member of the Present System does shopping at an affiliate store that applies point system.

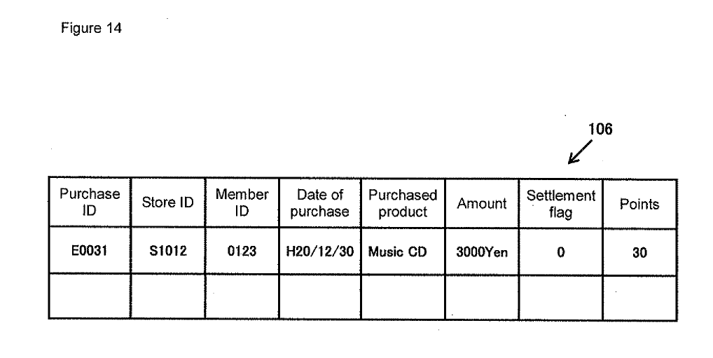

From store terminal [6], purchase history information such as the sold product, product price and sales date as well as provided points, store ID and member ID are received (Step S101). This processing corresponds to Step S36 in FIG. 9 of the first embodiment. Purchase history registration system [109] registers the received information in purchase history database [106] (Step S102). A sample of FIG. 14 shows that 30 points are provided by purchasing a product of 3,000 yen.

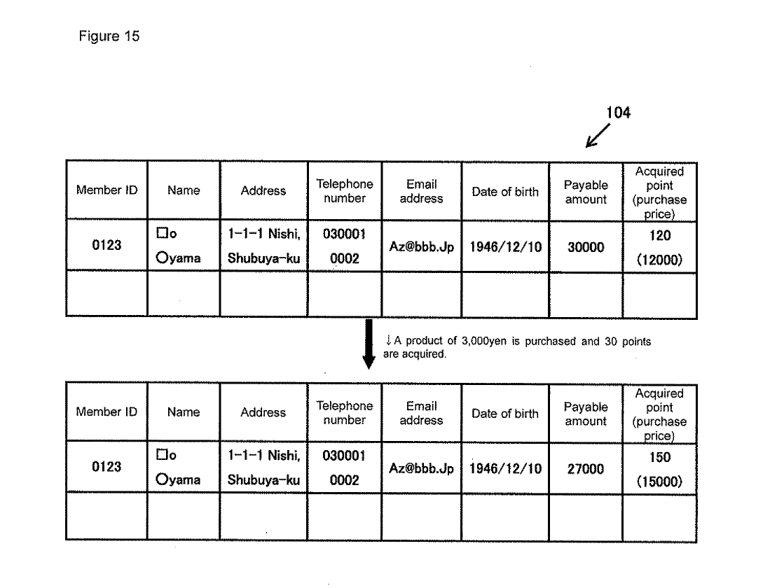

Point management system [110] renews by adding points newly provided to the current acquired points of a member who made purchase from member information database [104] (Step S103), and renews acquired point database [107] (Step S104). A sample in FIG. 15 shows that 120 points before renewal became 150 points. In this sample, the number of points and purchase price that corresponds to acquired points are memorized.

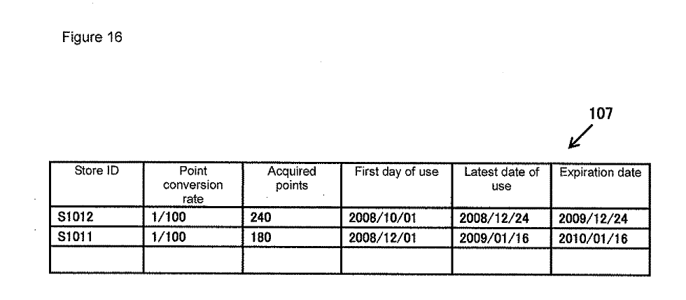

Acquired point database [107], as illustrated in FIG. 16, memorizes the number of accumulated points of the concerned store and conversion rate extracted from store information database [105] by corresponding to store ID. Here, the value calculated by dividing the accumulated points by conversion rate is the purchase price on which point acquirement at such store is based. The purchase price at the store with ID “S1012” in FIG. 16 is 24,000 yen (=240/( 1/100)).

Additionally, the first date of using such store's points and the latest date thereof are also memorized. The date calculated by adding the period of validity (1 year in this sample) to the latest date of use is memorized as the expiration date. Point system is often accompanied by the rule to invalidate acquired points after a long time of no use. Therefore, it is imperative to check the date.

Here, acquired point database [107] is to memorize how many points are acquired at which store as the whole SNS, and information of which member acquired points at which store is not necessary. Member information database [104] records how many points are acquired in total, but information of at which store such points were acquired is not necessary.

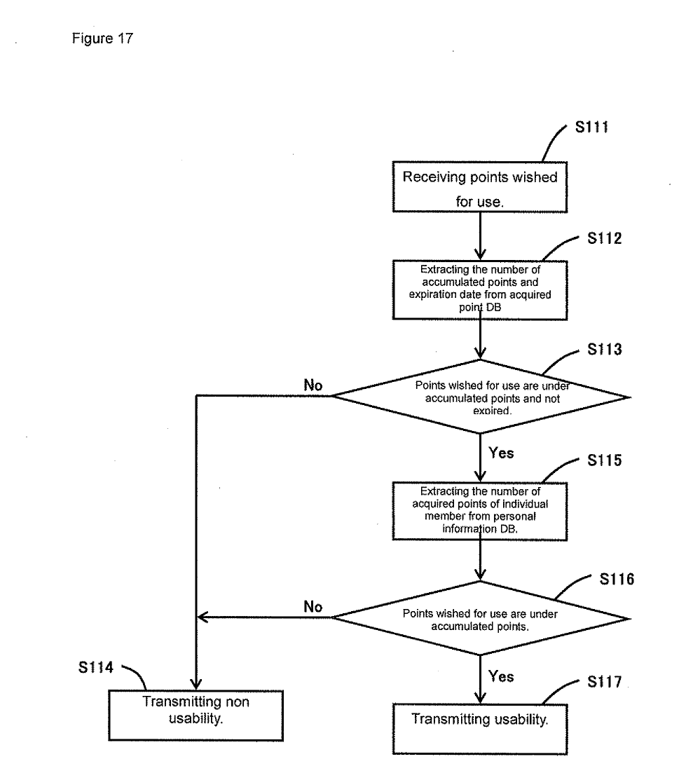

Next explanation is processing of the system control computer [101] when a member of the Present System shops using acquired points at a store that applies point system in accordance with FIG. 17.

The number of points the member wishes to use, and member ID and store ID (Step S111) are received from the store terminal [6].

Point management system [110] extracts the number of accumulated points and expiration date from acquired point database [107] based on store ID (Step S112).

When the number of accumulated points is less than the number of points desired to use, or expired (“NO” in Step S113), notification of non usability is transmitted to the store terminal [6] (Step 5114).

When the number of accumulated points is more than the number of points desired to use, and not expired (“YES” in Step S113), the number of acquired points of such member is extracted from member information database [104] based on member ID (Step S115). When the number of accumulated points of an individual member is less than the number of points desired to use, or expired (“NO” in Step S116), notification of non usability is transmitted to the store terminal [6] (Step S114). In other cases (“YES” in Step S116), notification of usability is transmitted to the store terminal [6] (Step S117).

If conversion rate differs depending on the affiliate store, judgment processing in Step S116 is done in the following manner. Point conversion rate of such store is extracted from store information DB [107], and amount of the points desired to use is calculated by dividing the points desired to use by this point conversion rate. If the concerned member's purchase price extracted from member information database [104] is not under the number of points desired to use, it is judged that the points are usable. That is, if conversion rate of all affiliate stores is equal, the numbers of points can simply be compared, but if conversion rate differs depending on the affiliate store, comparison is done after converting the number of points to amount of money.

In the above second embodiment, it was explained that a member can use points within the limit of acquired points, but age limit can be also applied. For example, in judgment processing in Step S116 of FIG. 17, date of birth can be extracted from member information database [104] and point use can be permitted only when the member is within the age limit preliminarily determined. Supposedly, if point use is limited to use by a person of age over 60, accumulated points are used as if they were pension. It is possible to cover income reduction after aging by points accumulated during his/her younger age with more income and consumption desire. This can be also an advantage of the Present System.

In the above second embodiment, when purchasing a product, points are used for all or part of the payment. Part for which points are not used is premised as settlement from SNS Account [3] within the limit of payable amount. However, acquired points can be converted to amount of money and included into each member's payable amount, and all of the product price can be settled from SNS Account [3]. When including the acquired points into payable amount, age limit can be also applied.

In the above embodiment, evidence of payable amount is amount deposited in SNS Account [3], or a sum of amount deposited in SNS Account [3] and converted amount of the acquired points. Yet, the SNS can grant a member credit within a certain amount and later have the member return into SNS Account [3] the amount paid in advance by the SNS. That is, the SNS takes over the payment to the store, and charges to the member later on. It is so called credit function, but in stead of the SNS directly granting credit, an affiliate financial institution can also grant credit to the member.

In the system of the present invention, it is important that SNS performs as if it were one giant consumer by covering payment of members in advance and managing points at a lump sum. Therefore, data structures and processing flows in the above described embodiments are mere examples, and not limited thereto.

### INDUSTRIAL AVAILABILITY

Applying SNS which is gradually spreading, individual consumption expansion can be expected by formation of group purchase system that has advantages for all of consumers, manufacturers and vendors.

### DESCRIPTIONS OF SYMBOLS

1. SNS's operation body

2: Financial institution where SNS Account is opened

3: SNS Account

4: Affiliate store

5: (The first form's) System control computer

6: Store terminal

7: SNS Member

8: Member terminal

9: Memory section

10: Processing section

11: Communication interface system

12: Member information database

13: Store information database

14: Purchase history database

15: Settlement information database

16: Member information registration system

17: Store information registration system

18: Account activity inquiry system

19: Payable amount management system

20: Inquiry response system

21: Purchase history registration system

22: Settlement direction system

23: Member information provision system

N: Communication network

101: (The second embodiment's) System control computer

102: Memory section

103: Processing section

104: Member information database

105: Store information database

106: Purchase history database

107: Acquired point database

108: Store information registration system

109: Purchase history registration system

110: Point management system

1. A group purchase system using the SNS where payment of product purchase price by an SNS Member is made by withdrawal from an account opened at a financial institution under the name of such SNS (hereinafter “SNS Account”), wherein.
the group purchase system control computer and store computer used by an affiliate store that provides products are connectable to each other via the Internet, and the control computer comprises a memory section and a processing section, wherein
the memory section includes:
a member information database that memorizes by corresponding a member's identification information to payable amount;
a store information database that memorizes by corresponding an affiliate store's identification information to settlement institution;
a purchase history database that memorizes history of purchase by a member at an affiliate store; and
a settlement information database that memorizes by corresponding settlement date and settled amount to settlement institution, wherein.
the processing section includes:
an inquiry response system that receives from the store computer sales suitability inquiry request, and member identification information and price of product which such member wishes to purchase, and that responds whether the product price is within the limit of such member's payable amount extracted from the member information database;
a purchase history registration system that registers purchase information including the price transmitted from the store computer and store identification information into the purchase history database when the product price is within the payable amount;
a settlement direction system that extracts a settlement institution of the store that transmits the purchase information from the settlement information database, and directs the financial institution where the SNS Account has been opened to remit money into the store's settlement institution from such SNS Account at the prescribed timing; and
a payable amount management system that set and renews payable amount of each member in the member information database.

2. The group purchase system using the SNS described in claim 1, wherein
the control computer further comprises an acquired point database and point management system, and
the point management means register added value information issued to the SNS by an affiliate store where a member purchases a product and such store's identification information into the acquired point database, and renews and registers added value information acquired and summed separately for each member into the p member information database.

3. The group purchase system using the SNS described in claim 1, wherein
The control computer further comprises an account activity inquiry system that inquires account activity information regarding the SNS Account to the financial institution where such SNS Account has been opened, and
when the account activity inquiry system receives deposit information including a member's identification information and deposit amount, the payable amount management system add the received deposit amount to such member's payable amount in the member information database.

4. The group purchase system using the SNS described in claim 1, wherein
in regard to a member granted with credit within the prescribed limit by the concerned SNS or a financial institution that conducts credit administration, the payable amount management system add amount within the credit limit granted to such member's payable amount in the member information database.

5. The group purchase system using the SNS described in claim 2, wherein
the payable amount management system add amount converted from all or part of the acquired point of the concerned member by the prescribed method to payable amount in the member information database.

6. The group purchase system using the SNS described in claim 5, wherein
the member information database includes information that indicates a member's age, and the payable amount management means add the converted amount only for the member whose age meets the prescribed condition.

7. The group purchase system using the SNS described in claim 1, wherein
a member terminal used by an SNS Member is connectable to the control computer via communication network, and the control computer further comprises the member information provision system that transmits information regarding such member including the payable amount and the purchase history for request from the member terminal.

8. A method by a computer connectable via the Internet to store computer used by an affiliate store that provides products for group purchase using the SNS where payment of product price by an SNS Member is made through withdrawal from SNS Account opened at a financial institution under such SNS's name, wherein
the computer is connected to a memory system including:
a member information database that memorizes by corresponding a member's identification information with payable amount;
a purchase history database that memorizes history of purchase by a member at an affiliate store, and;
a settlement information database that memorizes by corresponding an affiliated store's identification information with settlement institution, and performs:
a step of receiving sales suitability inquiry request from the store computer with a member identification information and price of the product the concerned member wishes to purchase, and to respond whether the product price is within the limit of such member's payable amount extracted from the member information database;
a step of registering purchase information including price transmitted from the store computer and store identification information into the purchase history database when the product price is within the payable amount;
a step of extracting a settlement institution of a store that transmits the purchase history information from the settlement information database, and direct a financial institution where the SNS Account has been opened to remit money to the store's settlement institution from the concerned SNS Account at the prescribed timing, and;
a step of setting and renewing payable amount of each member in the member information database.

9. The group purchase system using the SNS described in claim 8, wherein
the memory system further includes acquired point database, and the computer registers added value information issued to the SNS by an affiliate store where a member purchases a product and such store's identification information into the acquired point database, as well as summing, renewing and registering added value information acquired separately for each member into the member information database.
